(19) United States
(12) Patent Application Publication
(10) Pub. No.: US 2024/0347740 A1
(43) Pub. Date: Oct. 17, 2024

(54) MULTILAYER SEPARATOR AND METHOD FOR PRODUCING SAME

(71) Applicant: SHIN-ETSU POLYMER CO., LTD., Tokyo (JP)

(72) Inventors: Masahiro TESHIMA, Saitama (JP); Masayuki HONDA, Saitama (JP); Akira OKADA, Saitama (JP)

(21) Appl. No.: 18/293,358

(22) PCT Filed: Aug. 3, 2021
(86) PCT No.: PCT/JP2021/028699

§ 371 Date: Jan. 30, 2024

(51) Int. Cl. H01M 8/0228; H01M 8/0213; H01M 8/0221; H01M 8/10

(52) U.S. Cl. CPC H01M 8/0228; H01M 8/0213; H01M 8/0221; H01M 2008/1095

(57) ABSTRACT

There is provided a multilayer separator capable of stabilizing a gas barrier property at a high level. The present invention is related to a multilayer separator 1 and a method for producing the same, and the multilayer separator comprises: a plate that is a plate that contains graphite and resin and comprises, on surfaces thereof, grooves serving as flow paths; and at least one internal barrier layer, for a gas barrier, that is inside the plate in a thickness direction and divides the thickness direction into at least two areas.

### RELATED APPLICATIONS

The present application is a National Phase of International Application No. PCT/JP2021/028699 filed Aug. 3, 2021.

### CROSS REFERENCE

The contents of the patents, patent applications, and documents cited in the present application are incorporated herein by reference.

### TECHNICAL FIELD

The present invention is related to a multilayer separator and a method for producing the same.

### BACKGROUND ART

Fuel cells are cells from which energy is taken out by using a reaction between hydrogen and oxygen. Because what is generated from the reaction is water, fuel cells are known to be earth environment-friendly cells. In particular, for the capability of achieving high power density while being compact and lightweight, solid polymer fuel cells are considered as a favorable candidate for batteries of automobiles, communication devices, electronic devices and the like, while the actual implementation thereof is also partially underway. A fuel cell is a cell stack in which a plurality of cells are stacked together. Wall members called separators are arranged between the cells. Each separator is a partition for separating paths for hydrogen and oxygen positioned adjacent to each other and plays a role in making the hydrogen and the oxygen flow while being in uniform contact with the entire surface of an ion exchange membrane. For this reason, grooves serving as flow paths are formed on the separators.

From a viewpoint of constituent materials, separators can roughly be divided into a metal material group and a carbon material group. For separators in the metal material group, generally speaking, stainless steel, aluminum or an alloy thereof, or titanium or an alloy thereof may be used. The separators in the metal material group have excellent processability and can be very thin, due to strength and ductility specific to metal. However, the separators in the metal material group have higher specific gravity than separators in the carbon material group (explained later) and thus contradict the idea of making fuel cells lightweight. In addition, the separators in the metal material group have disadvantages where corrosion resistance is low, and a passive film may be formed by some of the materials. Because of the possibility of an increase in electrical resistance of the separators, corrosion and passive films of metal materials are not desirable. When separators in the metal material group are coated with precious metal plating or sputtering to improve corrosion resistance, costs may increase. To keep the costs down, a method is known by which ridge parts of flow paths formed on a surface of a separator are formed with a photoresist film (see Patent Literature 1).

In contrast, the separators in the carbon material group have advantages where specific gravity is lower while corrosion resistance is higher, in comparison to the separators in the metal material group. However, the separators in the carbon material group are inferior in processability and mechanical strength. In addition, there is demand for making electrical resistance even lower (i.e., making electrical conductivity even higher). As a method for improving the mechanical strength, a separator is known, for example, in which graphite particles are dispersed in thermoplastic resin (see Patent Literature 2).

### CITATION LIST

### Patent Literature

Patent Literature 1: Japanese Patent Laid-Open No. 2011-090937
Patent Literature 2: Japanese Patent Laid-Open No. 2006-294407

### SUMMARY OF INVENTION

### Technical Problem

The inventors belonging to the present applicant have previously developed a separator that comprises films made of resin (especially preferably polyphenylene sulfide) on two surfaces of a separator in the carbon material group in the thickness direction (Japanese Patent Application No. 2020-072036). Since the separator comprises a film made of resin, it has higher strength than conventional separators and also has high gas barrier performance. However, a higher and more stable gas barrier property are desired for separators arranged between cells in cells including fuel cells.

An object of the present invention is to provide a multilayer separator capable of stabilizing a gas barrier property at a high level.

### Solution to Problem

(1) A multilayer separator according to an embodiment for achieving the above-mentioned object comprises:
a plate that contains graphite and resin and comprises a groove serving as a flow path on a surface of the plate; and
at least one internal barrier layer, for a gas barrier, that is inside the plate in a thickness direction and divides the thickness direction into at least two areas.

(2) In a multilayer separator according to another embodiment, the internal barrier layer may preferably be a film-like layer different from the plate.

(3) In a multilayer separator according to yet another embodiment, the internal barrier layer may preferably be a filling layer in which resin or rubber fills spaces between particles or fibers structuring the plate.

(4) In a multilayer separator according to yet another embodiment, the internal barrier layer may preferably comprise the filling layer and a film-like layer different from the plate.

(5) A multilayer separator according to yet another embodiment may preferably further comprise two or more of the internal barrier layers.

(6) In a multilayer separator according to yet another embodiment, the internal barrier layer may preferably contain at least one selected from between polyether ether ketone and polyphenylene sulfide.

(7) In a multilayer separator according to yet another embodiment, the internal barrier layer may preferably contain at least one selected from between stainless steel and graphite.

(8) A multilayer separator according to yet another embodiment may preferably further comprise at least one surface barrier layer for a gas barrier on at least one side surface of the plate in the thickness direction.

(9) In a multilayer separator according to yet another embodiment, the surface barrier layer may preferably contain at least one selected from between polyether ether ketone and polyphenylene sulfide.

(10) A multilayer separator according to yet another embodiment may preferably further comprise the internal barrier layer and the surface barrier layer, in which a thickness of the internal barrier layer is larger than a thickness of the surface barrier layer.

(11) A multilayer separator according to yet another embodiment may preferably be a fuel cell separator to be used between cells in a fuel cell.

(12) A method for producing a multilayer separator according to an embodiment for achieving the above-mentioned object is a method for producing any one of the above-mentioned multilayer separators, and the method comprises:
a first mixture supplying step of supplying a mixture containing graphite and resin into a mold;
a middle layer film arranging step of arranging a middle layer film for forming the internal barrier layer over the mixture in the mold;
a second mixture supplying step of supplying the mixture over the middle layer film; and
a shaping step of forming a shaped body by hardening a layered structure containing at least the mixture, the middle layer film, and the mixture,
in which before the shaping step, the middle layer film arranging step and the second mixture supplying step are each repeated once or more.

(13) A method for producing the multilayer separator according to another embodiment may preferably be a method for producing a multilayer separator comprising the internal barrier layer and at least one surface barrier layer for a gas barrier on at least one side surface of the plate in the thickness direction, and the method comprises
a surface layer film arranging step of arranging a surface layer film, for forming the surface barrier layer, in a mold,
in which the first mixture supplying step, the middle layer film arranging step and the second mixture supplying step are performed after, before, or both before and after the surface layer film arranging step.

(14) In a method for producing the multilayer separator according to yet another embodiment, a pre-shaping step may preferably be performed for obtaining the layered structure in a semi-hardened state before the shaping step.

(15) In a method for producing the multilayer separator according to yet another embodiment, the surface layer film arranging step may preferably be performed between the pre-shaping step and the shaping step.

(16) In a method for producing the multilayer separator according to yet another embodiment, the multilayer separator may preferably be a fuel cell separator to be used between cells in a fuel cell.

### Advantageous Effect of Invention

According to the present invention, the gas barrier property can be stabilized at a high level.

### BRIEF DESCRIPTION OF DRAWINGS

FIG. 1 presents a plan view of a multilayer separator according to a first embodiment of the present invention.

FIG. 2A presents a cross-sectional view of the multilayer separator in FIG. 1 at A-A and an enlarged view of B which is a part thereof.

FIG. 2B presents enlarged views of variations a, b, c, and d of C which is a part of B being a part of FIG. 2A.

FIG. 2C presents enlarged views of variations a, b, and c of D which is a part of B being a part of FIG. 2A.

FIG. 3 shows an example of a flow in main steps in a producing method according to a first embodiment.

FIG. 4 presents cross-sectional views of statuses at the steps in the producing method in FIG. 3.

FIG. 5 presents cross-sectional views of statuses at the steps following FIG. 4.

FIG. 6 shows an example of a flow in main steps in a producing method according to a second embodiment.

FIG. 7 presents cross-sectional views of statuses at the steps in the producing method in FIG. 6.

FIG. 8 presents cross-sectional views of statuses at the steps following FIG. 7.

FIG. 9 presents a cross-sectional view of a status in which grooves are formed in pre-shaped body in a semi-hardened state, in a multilayer separator producing method according to a modification example.

FIG. 10 presents a cross-sectional view of a multilayer separator according to the second embodiment at A-A similar to FIG. 2A and an enlarged view of B which is a part thereof.

FIG. 11 shows an example of a flow in main steps in a separator producing method according to the second embodiment.

FIG. 12 shows an example of a flow in main steps in a producing method different from FIG. 11.

### DESCRIPTION OF EMBODIMENTS

Embodiments of the present invention will be explained with reference to the drawings. Each embodiment described below does not limit the invention set forth in the patent claims. Further, the various elements described in each embodiment and combinations thereof are not all necessarily requisite for the problem-solving means of the present invention.

### First Embodiment

### 1. A Multilayer Separator

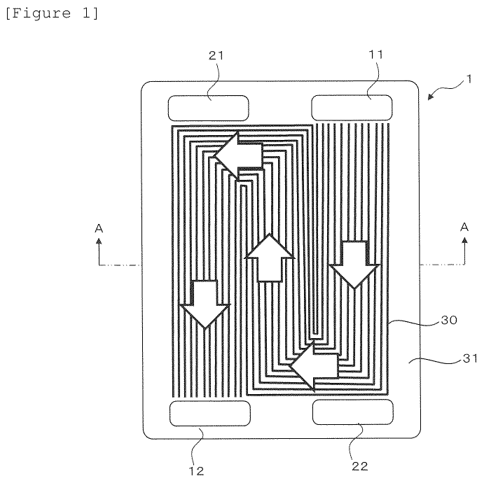

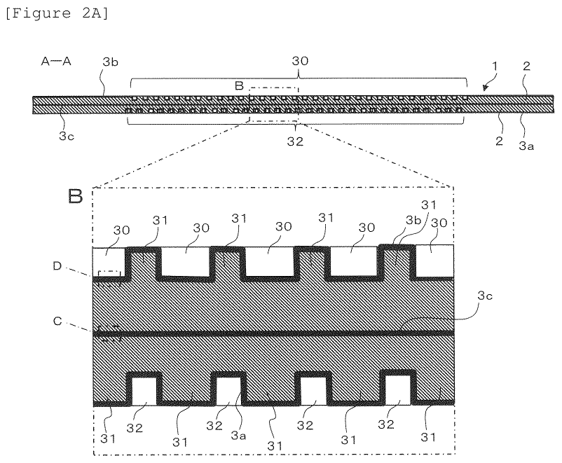

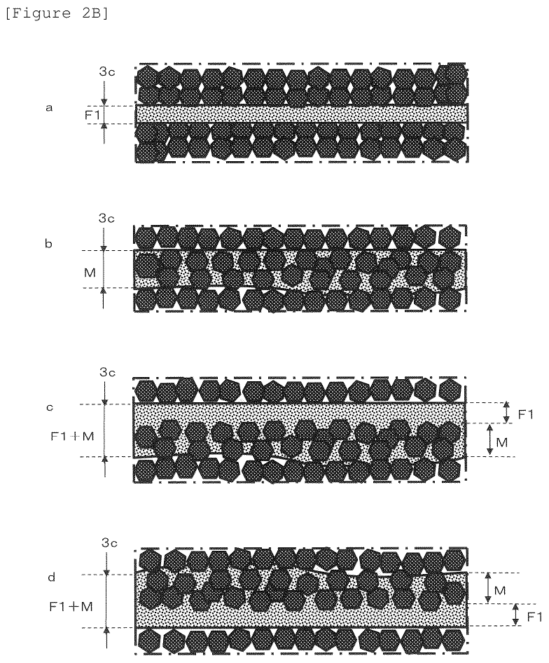

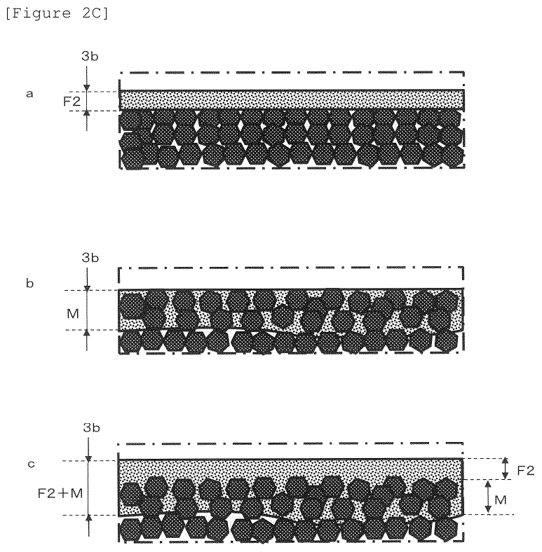

FIG. 1 presents a plan view of a multilayer separator according to a first embodiment of the present invention. FIG. 2A presents a cross-sectional view of the multilayer separator in FIG. 1 at A-A and an enlarged view of B which is a part thereof.

A multilayer separator (hereinafter also simply referred to as a “separator”) 1 according to the present embodiment is a plate-like body that is substantially rectangular in a planar view. In a fuel cell, for example, the separator 1 is a plate-like body that may sandwich, from both sides, a Membrane Electrode Assembly (MEA) in which an electrolyte membrane is interposed between an air electrode and a hydrogen electrode positioned on the two surfaces thereof. In the present embodiment, the separator 1 is interpreted in a broader sense including an anode-side separator provided on the hydrogen electrode (which may be called “anode electrode”) side and a cathode-side separator provided on the air electrode (which may be called “cathode electrode”) side. In the present embodiment, the separator 1 is a separator in the carbon material group. Further, the separator 1 is not limited to use in fuel cells but can also be used in a plate-like member arranged between cells of other cells (preferably a storage cells).

The separator 1 comprises through holes 11, 12, 21, and 22 penetrating in the thickness direction thereof. The through holes 11, 21 are positioned on one end side of the separator 1. The through hole 12 is positioned on the other end side opposite the one end side of the separator 1, while being positioned opposite the through hole 21 in a planar view of the separator 1. The through hole 22 is positioned on the other end side opposite the one end side of the separator 1, while being positioned opposite the through hole 11 in a planar view of the separator 1. On one of the surfaces (a front surface) of the separator 1, grooves 30 serving as flow paths are formed. A surface 31 other than the grooves 30 is formed as a raised plane in contrast to the grooves 30. On the other surface (a rear surface) on the opposite side of the one surface of the separator 1, grooves 32 serving as flow paths are formed. A surface 31 other than the grooves 32 is formed as a raised plane in contrast to the grooves 32.

When the separator 1 is a cathode-side separator, the through hole 11 serves as an oxidization gas supply opening. The through hole 12 serves as an oxidization gas discharge opening. The through hole 21 serves as a hydrogen gas discharge opening. The through hole 22 serves as a hydrogen gas supply opening. The oxidization gas may be air, for example, but may be oxygen. The grooves 30 on the front surface of the separator 1 serve as flow paths in which the oxidization gas flows. The grooves 32 on the rear surface of the separator 1 serve as flow paths in which cooling water flows. In FIG. 1, the white arrows indicate flows of the oxidization gas.

When the separator 1 is an anode-side separator, the through hole 11 serves as a hydrogen gas supply opening. The through hole 12 serves as a hydrogen gas discharge opening. The through hole 21 serves as an oxidization gas discharge opening. The through hole 22 serves as an oxidization gas supply opening. The grooves 30 on the front surface of the separator 1 serve as flow paths in which the hydrogen gas flows. The grooves 32 on the rear surface of the separator 1 serve as flow paths in which cooling water flows.

The separator 1 comprises at least a plate 2 and an internal barrier layer 3c arranged inside the plate 2. In the present embodiment, the separator 1 preferably comprises surface barrier layers 3a, 3b on the opposite side surfaces of the plate 2 in the thickness direction.

### (The Plate)

The plate 2 is a plate that contains graphite and resin, and comprises, on the surfaces thereof, the grooves 30, 32 serving as the flow paths. The plate 2 is a shaped body containing the graphite and the resin and has a fine structure in which the graphite is dispersed in the resin that was melted and subsequently solidified. In addition to the graphite and the resin, the plate 2 may contain fiber. The fibers may be any type of fibers such as resin fibers, carbon fibers, or ceramic fibers, but preferably resin fibers, and more preferably aramid fibers. Providing the plate 2 with fibers can further increases the strength of the plate 2. The plate 2 comprises grooves corresponding to the grooves 30,32 of the separator 1. In a planar view, the area of the plate 2 is preferably in the range of 10 cm² to 1000 cm² and more preferably in the range of 100 cm² to 750 cm². The thickness of the plate 2 is preferably in the range of 0.1 mm to 20 mm, and more preferably in the range of 0.2 mm to 10 mm.

The resin structuring the plate 2 is not particularly limited but is preferably thermoplastic resin. Resin having excellent heat resistance is more preferable for the resin to structure the plate 2. More specifically, examples include: polyphenylene sulfide (PPS), polyether ether ketone (PEEK), a polyamide (PA), polyether ketone ether ketone ketone (PEKEKK), polyether ketone (PEK), a liquid crystal polymer (LCP), polytetrafluoroethylene (PTFE), a copolymer of tetrafluoroethylene and ethylene (ETFE), polychlorotrifluoroethylene (PCTFE), polyimide (PI), a polyamide-imide (PAI), polyethersulfone (PES), polyphenylsulfone (PPSU), polyetherimide (PEI), and a polysulfone (PSU). Among these, PPS or PEEK is particularly preferable. Examples of PPS include M2888 and E2180 produced by Toray Industries, Inc. and FZ-2140 and FZ-6600 produced by Dainippon Ink and Chemicals, Inc.

The average particle diameter of the resin used before shaping the plate 2 is preferably in the range of 1 μm to 300 μm inclusive, more preferably in the range of 5 μm to 150 μm inclusive, and even more preferably in the range of 10 μm to 100 μm inclusive. In this situation, the average particle diameter denotes a particle diameter measured by using a laser diffraction/scattering particle diameter distribution measuring method. The same applies to the method for measuring the average particle diameters hereinafter.

The graphite structuring the plate 2 may be any of the following: artificial graphite, expanded graphite, natural graphite, and others. In this situation, the expanded graphite denotes graphite or a graphite intercalation compound obtained by expanding the spaces between graphite layers by having a layer of another substance enter (called “intercalation”) on a specific plane in a structure in which regular hexagonal planes of graphite are stacked together. As the expanded graphite, BSP-60A (having an average particle diameter of 60 μm) or EXP-50SM produced by Fuji Graphite Works Co., Ltd. may be used, for example. As the artificial graphite, 1707SJ (average particle diameter: 125 μm), AT-No. 5S (average particle diameter: 52 μm), AT-No. 10S (average particle diameter: 26 μm), or AT-No. 20S (average particle diameter: 10 μm) produced by Oriental Sangyo Co., Ltd. or PAG or HAG produced by Nippon Graphite Industries, Co., Ltd. may be used, for example. As the natural graphite, CNG-75N (average particle diameter: 43 μm) produced by Fuji Graphite Works Co., Ltd. or CPB (scale-shaped graphite powder having an average particle diameter of 19 μm) produced by Nippon Graphite Industries, Co., Ltd. may be used. Further, the shapes of the graphite particles are not particularly limited. It is possible to select from flakes, scale-like shapes, and spherical shapes, as appropriate. Further, the graphite may partially contain amorphous carbon.

The average particle diameter of the graphite used before shaping the plate 2 is preferably in the range of 1 μm to 500 μm inclusive, more preferably in the range of 3 μm to 300 μm inclusive, and even more preferably in the range of 10 μm to 150 μm inclusive.

The particle diameters of the graphite and the resin may be adjusted separately before the two are mixed together to be used for shaping the plate 2. Alternatively, the graphite and the resin may be kneaded together at first before being pulverized so that the particle diameters are adjusted for the use in shaping the plate 2. When the graphite and the resin are kneaded together before being pulverized so that the particle diameters are adjusted, the average particle diameter of a powder mixture is preferably in the range of 1 μm to 500 μm inclusive, more preferably in the range of 3 μm to 300 μm inclusive, and even more preferably in the range of 10 μm to 150 μm inclusive.

The mass ratio between the graphite and the resin structuring the plate 2 may be graphite:resin=70 to 95 parts by mass: 30 to 5 parts by mass. For example, by mixing 5 parts by mass of the resin with the graphite in an amount ranging from 70 parts by mass to 95 parts by mass inclusive, it is possible to obtain a constituent material of the plate 2. As another example, by mixing 30 parts by mass of the resin with the graphite in an amount ranging from 70 parts by mass to 95 parts by mass inclusive, it is also similarly possible to obtain a constituent material of the plate 2. It is preferable that the plate 2 contain more graphite than resin by a mass ratio. A more preferable mass ratio between the graphite and the resin is achieved by mixing 1 part by mass of the resin, with 10 parts by mass of the graphite or with the graphite in an amount ranging from 10.1 parts by mass to 20 parts by mass inclusive. As explained above, when more graphite than resin is used by parts by mass, because graphite particles have more contact sites with one another than in conventional separators, it is possible to further lower the electrical resistance (i.e., to further increase the electrical conductivity) of the separator 1. In a typical sample of the separator 1, volume resistivity is 5 mΩ·cm or lower.

### (The Internal Barrier Layers)

The internal barrier layer 3c is a gas barrier layer that is located inside the plate 2 in the thickness direction and divides the thickness direction into at least two areas. In the present embodiment, only one internal barrier layer 3c is provided in the plate 2. For this reason, the plate 2 is divided into two areas in the thickness direction of the plate 2 by one layer of the internal barrier layer 3c. However, the plate 2 may comprise two or more of the internal barrier layers 3c. In that case, the plate 2 is divided into three or more areas in the thickness direction of the plate 2 by the two or more internal barrier layers 3c.

FIG. 2B presents enlarged views of variations a, b, c, and d of C which is a part of B being a part of FIG. 2A.

A mode “a” is a mode in which the internal barrier layer 3c is provided inside the plate 2 in the thickness direction. In the mode “a”, an internal barrier layer 3c is a film-like layer F1 different from the plate 2. A mode “b” is a mode in which the internal barrier layer 3c impregnated with resin or rubber is provided inside the plate 2 in the thickness direction. In the mode “b”, the internal barrier layer 3c is a filling layer M in which the resin or the rubber fills the spaces between the particles or fibers structuring the plate 2. Further, in a mode “c” and a mode “d”, the internal barrier layers 3c each include a filling layer M and a layer F1. As explained herein, the internal barrier layer 3c preferably use one of modes a, b, c, and d. However, as long as the internal barrier layer 3c has a better gas barrier property than that of the plate 2, the internal barrier layer 3c may use a mode other than modes a, b, c, and d. In the present application, the “gas barrier” denotes a characteristic that prevents gas from passing through. In the following sections, the internal barrier layer 3c in the mode “a” will primarily be explained.

The internal barrier layer 3c is preferably a layer including resin or rubber. The internal barrier layer 3c may have excellent electrical conductivity or may have poor electrical conductivity. For the internal barrier layer 3c, one or two or more may be selected as principal material(s) from among the above-mentioned preferable options for the resin to structure the plate 2, and more preferably, at least one of PEEK and PPS may be used as the principal material(s). In this situation, the “principal material” denotes a material that accounts for more than 50 mass % of a film 3. As long as the principal material accounts for more than 50 mass % relative to the mass of the film 3, the percentage may be 51 mass %, 60 mass %, 70 mass %, 80 mass %, 90 mass %, 95 mass %, or 100 mass %, for example. Note that the internal barrier layer 3c contains at least one of PEEK and PPS but does not need to contain it as the principal material. The internal barrier layer 3c may also be a layer using a graphite film obtained by carbonizing and crystallizing a resin such as polyimide, polyamide-imide, polybenzimidazole, polyamide, or polyoxazole through high-temperature heat treatment. Examples of such graphite films include Graphinity produced by Kaneka Corporation and PGS graphite sheet manufactured by Panasonic Corporation. Furthermore, the internal barrier layer 3c may be a layer using metal. In this case, metals to be suitably used include stainless steel (SUS301, SUS304, SUS316L, SUS430, SUS630, etc.), copper C1020, and titanium TP270.

The thickness of the internal barrier layer 3c is preferably in the range of 2 μm to 100 μm inclusive, more preferably in the range of 2 μm to 75 μm inclusive, and even more preferably in the range of 5 μm to 50 μm inclusive. When the thickness of the internal barrier layer 3c is 2 μm or larger, or even 5 μm or larger, it is possible to further enhance the gas barrier performance, to further enhance the strength (the bending strength), and to further enhance tractability of the separator 1. Contrarily, when the thickness of the internal barrier layer 3c is set to 100 μm or smaller, further 75 μm or smaller, and still further 50 μm or smaller, the volume resistivity can be lowered. In the present embodiment, the strength denotes a bending strength measured according to JIS K7171.

The principal material of resin structuring the plate 2 and the principal material of resin structuring the internal barrier layer 3c may be the same type of thermoplastic resin. In that case, the resin near the internal barrier layer 3c of the plate 2 and the resin structuring the internal barrier layer 3c can be partially integrated, so that the strength of the separator 1 can be further increased. The thermoplastic resin is, preferably, PEEK or PPS.

When the internal barrier layer 3c is provided inside the plate 2 and the surface barrier layers 3a, 3b are arranged on the front side and/or the rear side in the thickness direction of the plate 2, the gas barrier property can be improved even if the thickness of the surface barrier layers 3a, 3b is made smaller. Further, although the surface barrier layers 3a, 3b have a risk of being torn at the grooves 30, 32, but, even in that case, the gas barrier property can be maintained favorably due to the presence of the internal barrier layer 3c. Further, even if at least one of the surface barrier layers 3a, 3b is not provided, the gas barrier property can be maintained favorably due to the presence of the internal barrier layer 3c.

### (The Surface Barrier Layer)

In the present embodiment, as described above, the surface barrier layers 3a, 3b for a gas barrier are further provided on the opposite side surfaces of the plate 2 in the thickness direction. Note that only either of the surface barrier layer 3a and the surface barrier layer 3b may be provided on one side surface of the plate 2 in the thickness direction.

The surface barrier layers 3a, 3b cover the front side surface and the rear side surface of the plate 2 including the grooves 30, 32 and the surfaces 31 of the plate 2 other than the grooves 30, 32. In other words, the surface barrier layers 3a, 3b cover both surfaces of the plate 2, namely the surface on the front side and the surface on the rear side, including the faces inside the grooves 30, 32. In the present embodiment, the surface barrier layer 3a covers one side surface of the plate 2 in the thickness direction, and the surface barrier layer 3b covers the other side surface thereof in the thickness direction. However, a surface barrier layer may have a bag shape that wraps around the outer surface of the plate 2 in a state where the surface barrier layer 3a and the surface barrier layer 3b are joined together.

FIG. 2C presents enlarged views of variations a, b, and c of D which is a part of B being a part of FIG. 2A.

A mode “a” comprises a film, a principal material of which is preferably resin or rubber, on a surface of the plate 2. In the mode “a”, a surface barrier layer 3b is a film-like covering layer F2 different from the plate 2. Further, a mode “b” comprises a surface barrier layer 3b that is formed in such a way that the plate 2 is, in the vicinity of the surface thereof, impregnated with resin or rubber. In the mode “b”, the surface barrier layer 3b is a filling layer M in which the resin or the rubber fills the spaces between the particles or fibers structuring the plate 2. Further, in a mode “c”, a surface barrier layer 3b includes a filling layer M and a covering layer F2. As explained herein, the surface barrier layer 3b (the same applies to 3a) preferably employs a mode of a, b, or c. However, as long as the surface barrier layers 3a, 3b each have a better gas barrier property than that of the plate 2, the surface barrier layer 3a, 3b may employ a mode other than modes a, b, and c. In the present application, the “gas barrier” denotes a characteristic that prevents gas from passing through. In the following sections, the surface barrier layers 3a, 3b in the mode “a” will primarily be explained.

The surface barrier layers 3a, 3b are preferably layers including resin or rubber. The surface barrier layers 3a, 3b may have excellent electrical conductivity or may have poor electrical conductivity. The surface barrier layers 3a, 3b include, as principal material(s), one or two or more selected from among the above-mentioned preferable options for the resin structuring the plate 2, and more preferably, include at least one of PEEK and PPS as the principal material(s). In this situation, the “principal material” denotes a material that accounts for more than 50 mass % of the surface barrier layers 3a, 3b. As long as the principal material accounts for more than 50 mass % relative to the mass of the surface barrier layers 3a, 3b, the percentage may be 51 mass %, 60 mass %, 70 mass %, 80 mass %, 90 mass %, 95 mass %, or 100 mass %, for example. Note that the surface barrier layers 3a, 3b contain at least one of PEEK and PPS, but do not need to contain it as the principal material.

The preferred thickness range of the surface barrier layers 3a, 3b and the advantages with the thickness range are the same as those for the internal barrier layer 3c. Note that the thickness of the surface barrier layers 3a, 3b is preferably smaller than the thickness of the internal barrier layer 3c. This is because the surface barrier layers 3a, 3b can be easily brought into close contact along the outer surface of the plate 2 including the grooves 30, 32. Furthermore, in forming cells and cell stacks, if the thickness of the surface barrier layers 3a, 3b of the separator 1 are small, the surface barrier layers 3a, 3b are less likely to serve as insulating layers. This can reduce the contact resistance.

The principal material of resin structuring the plate 2 and the principal material of resin structuring the surface barrier layers 3a, 3b may be the same type of thermoplastic resin. In that situation, it is possible to integrally form the resin in the vicinity of the surface of the plate 2 with the surface barrier layers 3a, 3b covering the plate 2, allowing further increase in the strength of the separator 1. The thermoplastic resin is, preferably, PEEK or PPS.

### 2. A Multilayer Separator Producing Method

Next, a multilayer separator producing method according to the first embodiment of the present invention will be explained.

The separator 1 includes: a first mixture supplying step of supplying a mixture containing graphite and resin into a mold; a middle layer film arranging step of arranging a middle layer film 6 for forming an internal barrier layer 3c over the mixture in the mold; a second mixture supplying step of supplying the mixture over the middle layer film 6; a shaping step of hardening a layered structure including at least the mixture, the middle layer film 6, and the mixture to make the structure into a shaped body; Further, before the shaping step, the middle layer film arranging step and the second mixture supplying step are each repeated once or twice or more. The method for producing the separator 1 (hereinafter also simply referred to as the “producing method”) includes at least one surface layer film arranging step of arranging surface layer films 4 and/or 5 in a mold. After, before, or both before and after the surface layer film arranging step, the first mixture supplying step, the middle layer film arranging step, and the second mixture supplying step are performed. In the following embodiments, the multilayer separator producing method is preferably a method for producing a fuel cell separator to be used between cells in a fuel cell. Further, the separator 1 is preferably a separator in the carbon material group. However, the separator 1 is not limited to use in fuel cells and can also be used in a plate-like member arranged between cells of other cells (preferably storage cells).

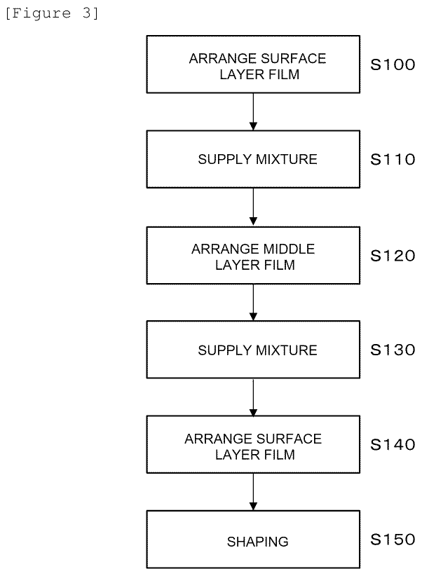

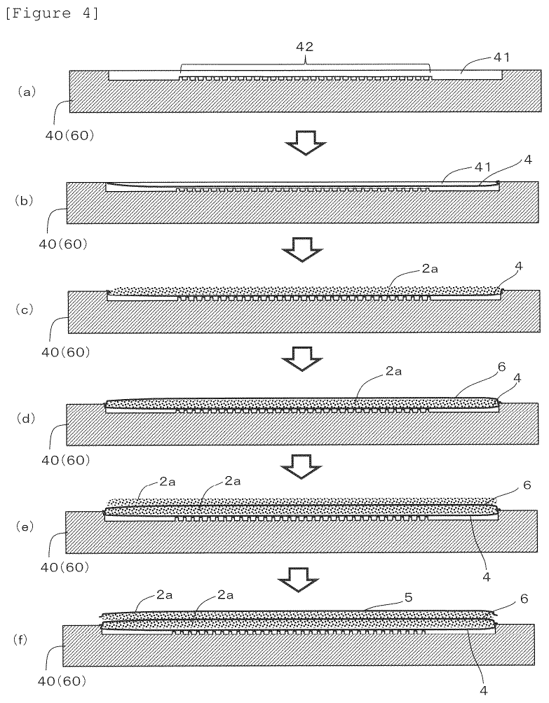

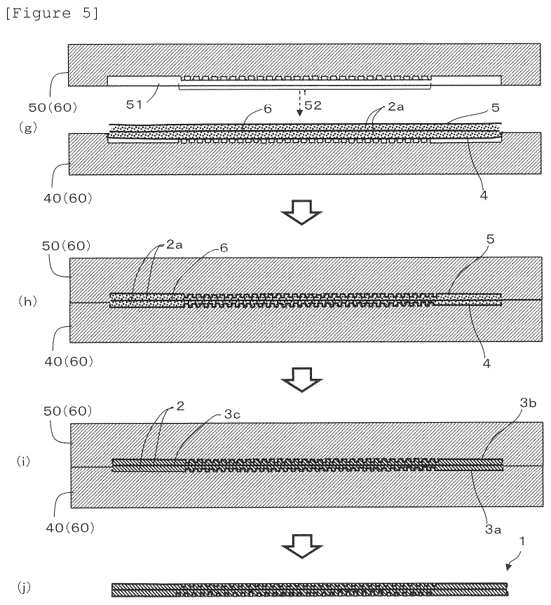

FIG. 3 shows an example of a flow in main steps in a producing method according to a first embodiment. FIG. 4 presents cross-sectional views of statuses at the steps in the producing method in FIG. 3. FIG. 5 presents cross-sectional views of statuses at the steps following FIG. 4.

The separator 1 can be produced through a surface layer film arranging step (S100) a first mixture supplying step (S110), a middle layer film arranging step (S120), a second mixture supplying step (S130), a surface layer film arranging step (S140), and a shaping step (S150). In the following sections, S100 through S150 will be explained in detail with reference to FIGS. 3 to 5.

### (1) The Surface Layer Film Arranging Step (S100)

This step is a step of arranging the surface layer film 4 in the mold 60. More specifically, a bottom mold 40 structuring the mold 60 is prepared, and the surface layer film 4 is placed in a recessed part 41 of the bottom mold 40 (see FIGS. 4 (a) and (b)). On the inner bottom face of the recessed part 41, the bottom mold 40 comprises an uneven surface 42 capable of transferring and forming the grooves 32.

### (2) The First Mixture Supplying Step (S110)

This step is a step of supplying the mixture 2a containing the graphite and the resin to the inside of a mold 60. More specifically, the mixture 2a is supplied over the surface layer film 4 placed in the bottom mold 40 (see FIG. 4 (c)).

### (3) The Middle Layer Film Arranging Step (S120)

This step is a step of arranging the middle layer film 6 over the mixture 2a in the mold 60. More specifically, the middle layer film 6 is placed over the mixture 2a over the surface layer film 4 arranged in the recessed part 41 of the bottom mold 40 (see FIG. 4 (d)).

### (4) The Second Mixture Supplying Step (S130)

This step is a step of supplying the mixture 2a containing the graphite and the resin to the inside of a mold 60. More specifically, the mixture 2a is supplied over the middle layer film 6 in the bottom mold 40 (see FIG. 4 (e)).

### (5) The Surface Layer Film Arranging Step (S140)

This step is a step of arranging the surface layer film 5 over the mixture 2a in the mold 60 after the second mixture supplying step (S130). More specifically, the surface layer film 5 is placed over the mixture 2a over the middle layer film 6 arranged in the recessed part 41 of the bottom mold 40 (see FIG. 4 (f)).

### (6) The Shaping Step (S150)

This step is a step of producing the shaped body by hardening the layered structure including the surface layer film 4, the mixture 2a, and the middle layer film 6, the mixture 2a, and the surface layer film 5. More specifically, the top mold 50 structuring the mold 60 is prepared and placed over the bottom mold 40 on the recessed part 41 side, and the bottom mold 40 and the top mold 50 are closed together (see FIGS. 5 (g) and (h)). The top mold 50 has a recessed part 51 on the side facing the recessed part 41 of the bottom mold 40. On the inner bottom face thereof, the recessed part 51 comprises an uneven surface 52 capable of transferring and forming the grooves 30. After the mold 60 is clamped, the layered structure is shaped by applying heat thereto. As a result, the mixture 2a is hardened and forms the plate 2. Further, as a result of the transfer of the uneven surfaces 41,51, the grooves 30,32 in the state of being covered by the surface barrier layers 3a, 3b are formed. Further, an internal barrier layer 3c is formed inside the plate 2 (see FIG. 5 (i)).

After the shaping step (S150), the mold 60 is opened, and the separator 1 is thus completed. Note that either of the surface layer film arranging step (S100) and the surface layer film arranging step (S140) may be omitted. Further, after the second mixture supplying step (S130), the set of the middle layer film arranging step (S120) and the second mixture supplying step (S130) may be repeated one or more times.

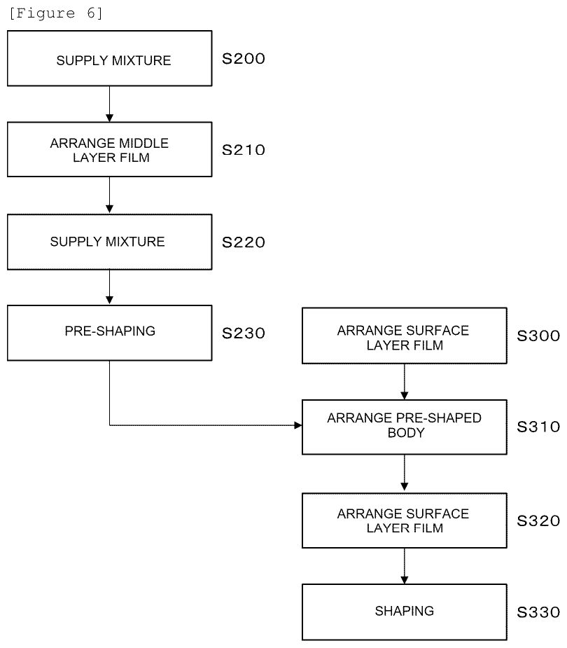

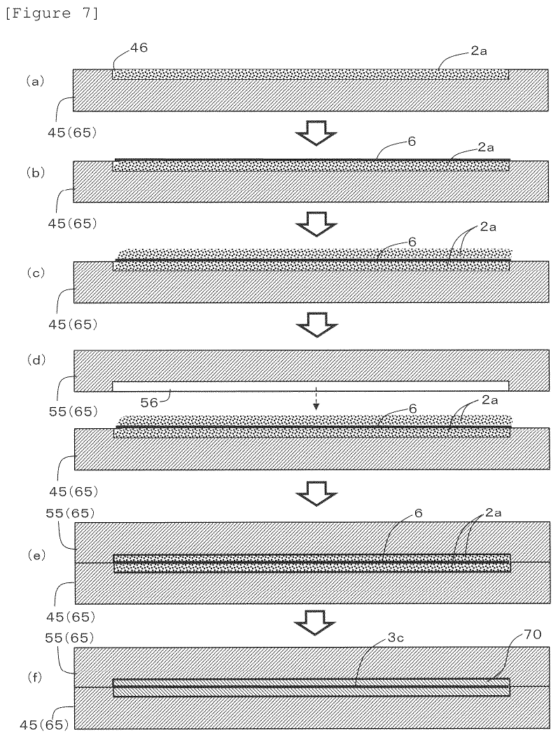

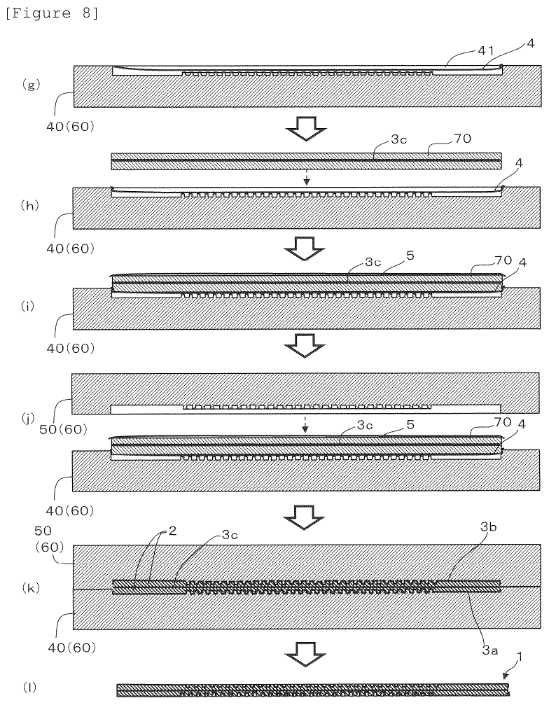

FIG. 6 shows an example of a flow in main steps in a producing method according to a second embodiment. FIG. 7 presents cross-sectional views of statuses at the steps in the producing method in FIG. 6. FIG. 8 presents cross-sectional views of statuses at the steps following FIG. 7.

In the producing method shown in FIG. 6, a semi-hardened layered body of the mixture 2a, the middle layer film 6, and the mixture 2a is produced, and then the layered body is sandwiched between the surface layer film 4 and the surface layer film 5 to be shaped, so that the separator 1 is produced. In other words, in the present producing method, before the shaping step, a pre-shaping step is performed to obtain the layered structure in the semi-hardened state.

The separator 1 can be produced through a first mixture supplying step (S200), a middle layer film arranging step (S210), a second mixture supplying step (S220), a pre-shaping step (S230), a surface layer film arranging step (S300), a pre-shaped body arranging step (S310), a surface layer film arranging step (S320), and a shaping step (S330). In the following sections, S200 through S230 and S300 through S330 will be explained in detail with reference to FIGS. 6 to 8.

### (1) The First Mixture Supplying Step (S200)

This step is a step of supplying the mixture 2a containing the graphite, and the resin to the inside of a mold 65. More specifically, the mixture 2a is supplied to a recessed part 46 of a bottom mold 45 (see FIG. 7 (a)).

### (2) The Middle Layer Film Arranging Step (S210)

This step is a step of arranging the middle layer film 6 over the mixture 2a inside the mold 65. More specifically, the middle layer film 6 is placed over the mixture 2a supplied in the recessed part 46 of the bottom mold 45 (see FIG. 7 (b)).

### (3) The Second Mixture Supplying Step (S220)

This step is a step of supplying the mixture 2a containing the graphite and the resin to the inside of the mold 65. More specifically, the mixture 2a is supplied over the middle layer film 6 in the bottom mold 45 (see FIG. 7 (c)).

### (4) Pre-Shaping Step (S230)

This step is a step of producing a pre-shaped body by semi-hardening the layered structure including the mixture 2a, the middle layer film 6, and the mixture 2a. More specifically, a top mold 55 structuring the mold 65 is prepared and placed over the bottom mold 45 on the recessed part 46 side, and the bottom mold 45 and the top mold 55 are closed together (see FIG. 7 (d), (e), and (f)). The top mold 55 has a recessed part 56 on the side facing the recessed part 46 of the bottom mold 45. After the mold 65 is clamped, the layered structure is semi-hardened by applying heat thereto. The temperature at this time is lower than the temperature in the shaping step. As a result, a pre-shaped body (layered structure in a semi-hardened state) 70 comprising the internal barrier layer 3c is completed.

### (5) The Surface Layer Film Arranging Step (S300)

This step is a step of arranging the surface layer film 4 in the mold 60 (FIG. 8 (g)). The details are the same as the surface layer film arranging step (S100) in the producing method according to the first embodiment.

### (6) The Pre-Shaped Body Arranging Step (S310)

This step is a step of arranging a pre-shaped body 70 over the surface layer film 4 placed in the recessed part 41 (see FIG. 8 (h)).

### (7) The Surface Layer Film Arranging Step (S320)

This step is a step of arranging the surface layer film 5 over the mixture 2a structuring the pre-shaped body 70 in the mold 60, after the pre-shaped body arranging step (S310) (see FIG. 8 (i)).

### (8) The Shaping Step (S330)

This step is a step of producing the shaped body by hardening the layered structure including the surface layer film 4, the pre-shaped body 70 (semi-hardened mixture 2a, middle layer film 6, and mixture 2a), and the surface layer film 5. More specifically, the top mold 50 structuring the mold 60 is prepared and placed over the bottom mold 40 on the recessed part 41 side, and the bottom mold 40 and the top mold 50 are closed together (see FIG. 8 (j)). After the mold 60 is clamped, the layered structure is shaped by applying heat thereto. As a result, the mixture 2a is hardened and forms the plate 2. Further, as a result of the transfer of the uneven surfaces 41,51, the grooves 30,32 in the state of being covered by the surface barrier layers 3a, 3b are formed (see FIGS. 8 (k) and (l)).

After the shaping step (S330), the mold 60 is opened, and the separator 1 is thus completed. Note that one selected from between the surface layer film arranging step (S300) and the surface layer film arranging step (S320) may be omitted. Further, after the second mixture supplying step (S220), the set of the middle layer film arranging step (S210) and the second mixture supplying step (S220) may be repeated one or more times.

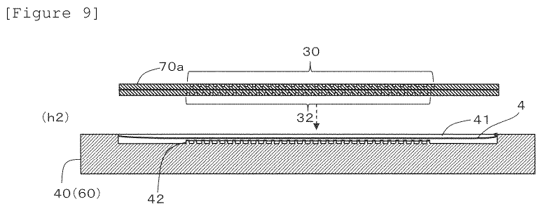

FIG. 9 presents a cross-sectional view of a status in which grooves are formed in a pre-shaped body in a semi-hardened state, in a multilayer separator producing method according to a modification example.

In the present modification example, the bottom mold 45 and the top mold 55 each have an uneven surface formed on the inner bottom face thereof, and the pre-shaped body arranging step (S310) produces a pre-shaped body 70a with grooves 30, 32. In the pre-shaped body arranging step (S310), the pre-shaped body 70a is arranged over the surface layer film 4 so that the grooves of the pre-shaped body 70a are aligned with the uneven surface 42 (see FIG. 9 (h2)). Then, the uneven surface 52 of the top mold 50 is aligned with the grooves of the pre-shaped body 70a, the top mold 50 and the bottom mold 40 are closed together, and the mold 60 is clamped. Thereafter, the shaping step (S330) of the producing method according to the second embodiment is executed, and the separator 1 is completed (FIGS. 8 (k) and (l)).

### Second Embodiment

Next, a second embodiment of the present invention will be explained. For the multilayer separator and the producing method thereof according to the second embodiment, duplicate explanations of some of the elements that are the same as those in the first embodiment shall be omitted, and the explanations in the first embodiment serve as a substitute.

### 1. A Multilayer Separator

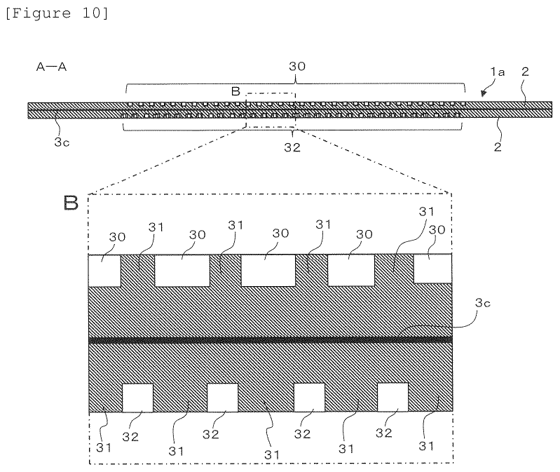

FIG. 10 presents a cross-sectional view of a multilayer separator according to the second embodiment at A-A similar to FIG. 2A and an enlarged view of B which is a part thereof.

A separator 1a according to the present embodiment comprises the plate 2 and the internal barrier layer 3c arranged inside the plate 2. The present embodiment differs from the separator 1 according to the first embodiment in that the separator 1a does not comprises the surface barrier layers 3a, 3b. The separator 1a is the same as the separator 1, except for not comprising the surface barrier layer 3a, 3b.

### 2. A Multilayer Separator Producing Method

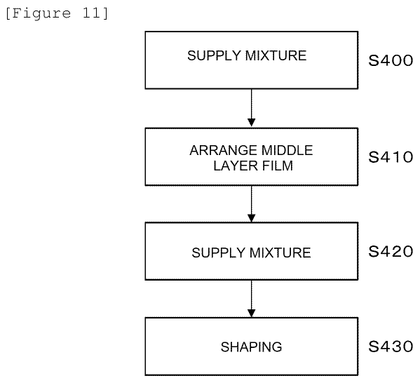

FIG. 11 shows an example of a flow in main steps in a separator producing method according to the second embodiment.

The separator 1a includes a first mixture supplying step (S400) of supplying a mixture containing graphite and resin into a mold, a middle layer film arranging step (S410) of arranging a middle layer film 6 for forming the internal barrier layer 3c over the mixture in the mold; a second mixture supplying step (S420) of supplying the mixture over the middle layer film 6; and a shaping step (S430) of hardening a layered structure containing at least the mixture, the middle layer film 6, and the mixture to form a shaped body. Further, after the second mixture supplying step (S420), the set of the middle layer film arranging step (S410) and the second mixture supplying step (S420) may be repeated one or more times. The first mixture supplying step (S400) corresponds to the first mixture supplying step (S110) except that the surface layer film 4 is not arranged in the mold 60. The middle layer film arranging step (S410) corresponds to the middle layer film arranging step (S120). The second mixture supplying step (S420) corresponds to the second mixture supplying step (S130). The shaping step (S430) corresponds to the shaping step (S150) except for being performed without arranging the surface layer films 4,5. Accordingly, explanations that are duplicates of those about the producing method of the separator 1 according to the first embodiment above will be omitted.

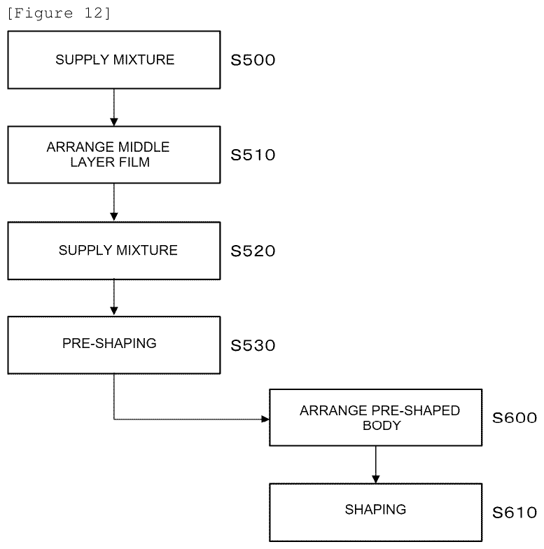

FIG. 12 shows an example of a flow in main steps in a producing method different from FIG. 11.

The separator 1a can be produced through a first mixture supplying step (S500), a middle layer film arranging step (S510), a second mixture supplying step (S520), a pre-shaping step (S530), a pre-shaped body arranging step (S600), and a shaping step (S610).

The first mixture supplying step (S500) corresponds to the first mixture supplying step (S200). The middle layer film arranging step (S510) corresponds to the middle layer film arranging step (S210). The second mixture supplying step (S520) corresponds to the second mixture supplying step (S220). The pre-shaping step (S530) corresponds to the pre-shaping step (S230). Further, after the second mixture supplying step (S520), the set of the middle layer film arranging step (S510) and the second mixture supplying step (S520) may be repeated one or more times. The pre-shaped body arranging step (S600) corresponds to the pre-shaped body arranging step (S310) except for being performed without going through the surface layer film arranging step (S300). The shaping step (S610) corresponds to the shaping step (S330) except for being performed without the surface layer film 4,5. Accordingly, explanations that are duplicates of those about the producing method of the separator 1 according to the first embodiment shown in FIG. 6 will be omitted.

### Other Embodiments

A number of preferable embodiments of the present invention have thus been explained. However, the present invention is not limited to those embodiments and may be carried out with various modifications.

The grooves 30 in the separator 1, 1a may be grooves forming flow paths other than the flow paths in which the gas flows in the directions shown with the white arrows in FIG. 1. Further, the grooves 32 may be grooves forming flow paths in any form. For example, the grooves 30 may be grooves forming linear flow paths extending from one end to the other end of the separator 1, while the grooves 32 may be grooves forming linear flow paths extending in a substantially perpendicular direction to the grooves 30. Further, the separator 1, 1a may be formed without at least one of the grooves 30 and the grooves 32.

In the above embodiment, the pre-shaped body 70 does not comprise any grooves corresponding to the grooves 30, 32 but may have grooves shallower than the grooves 30, 32. In that case, when the mold 60 is closed together for shaping process, the previously formed shallow grooves can be deepened and changed into the grooves 30,32.

After the shaping step, a trimming step may be performed to trim an extra area of the surface layer film 4, 5, or the middle layer film 6.

Although the separator 1 comprises the surface barrier layers 3a, 3b, the separator 1 may comprise only either the surface barrier layer 3a or the surface barrier layer 3b. When either of the surface barrier layer 3a and the surface barrier layer 3b is provided only on one side surface in the thickness direction of the plate 2, after or before the surface layer film arranging step, the first mixture supplying step, the middle layer film arranging step, and the second mixture supplying step can be performed. Further, the pre-shaped body arranging step may be performed that arranges the pre-shaped body 70 obtained by performing pre-molding through the first mixture supplying step, the middle layer film arranging step, and the second mixture supplying step after or before the surface layer film arranging step. The surface layer film arranging step may be performed between the pre-shaping step and the shaping step.

The producing method of each of the embodiments described above is a method for producing a fuel cell separator in which the internal barrier layer 3c (and the surface barrier layers 3a, 3b) are each a resin or a rubber layer. However, the producing method may be a producing method of a fuel cell separator in which these barrier layers 3a, 3b, and 3c each have a layer including a filling layer M such as the modes b, c, and d of FIG. 2B and the modes b and c of FIG. 2C.

### Examples

Next, Examples of the present invention will be explained while being compared with Comparison Examples. The present invention is not limited to the following Examples.

### 1. Main Ingredients of the Plate

### (1) Graphite

As graphite powder serving as a constituent material of the plate of multilayer separators (hereinafter also referred to as “separators”), the following two types of graphite powder were used: model number: 1707SJ (artificial graphite having an average particle diameter of 125 μm) produced by Oriental Sangyo Co., Ltd.; and model number: AT-No. 5S (artificial graphite having an average particle diameter of 52 μm) produced by Oriental Sangyo Co., Ltd.

### (2) Resin

As the resin serving as a constituent material of the plate of the separator, polyphenylene sulfide (PPS) powder was used. As the PPS, PPS fine powder was used that was adjusted to have an average particle diameter of 50 μm obtained by freezing and pulverizing PPS powder in a flake form, model number of which is Torelina M2888 (MFR600) produced by Toray Industries, Inc.

### (3) Aramid Fiber

As aramid fiber serving as constituent materials of separator plate, the following two types of aramid fiber that were both para-aramid fiber were used: Technora T32PNW 3-12 produced by Teijin Ltd. (having an average fiber length of 3.2 mm and an average fiber diameter of 18 μm); and Twaron (registered trademark) D8016 produced by Teijin Ltd. (having an average fiber length of 0.8 mm).

### 2. Pre-Treatment of Raw Ingredients Before Shaping

The graphite powder and the resin powder underwent ball mill pulverization using zirconia balls, so that the two types of powder were mixed and pulverized. The ball-mill pulverization was ended when it was confirmed that the granularity of the powder mixture reached an average particle diameter of 80 to 100 μm by measuring the granularity distribution (through a measuring process implementing a laser diffraction/scattering particle diameter distribution measuring method).

### 3. Surface Layer Film

As a surface layer film, a film made of PPS was used. As the film made of PPS, a film having a thickness of 9 μm (model number: Torelina 9-3071) produced by Toray Industries, Inc. was used.

### 4. Middle Layer Film

As the middle layer films, four types of films were used that were made of the following: PPS, PEEK, SUS304, and graphite. As the PPS film, a film was used that had a thickness of 25 μm (model number: Torelina 25-3030) produced by Toray Industries, Inc. As the PEEK film, a film was used that had a thickness of 6 μm produced by Shin-Etsu Polymer Co., Ltd. using a raw material produced by Solvay Specialty Polymers (model number: KT-851NL SP). As the SUS304 film, film was used that had a thickness of 20 μm (model number: SUS304 H-TA) produced by Nippon Kinzoku Co., Ltd. As the graphite film, a film was used that had a thickness of 32 μm (model number: Graphinity 32 μm) produced by Kaneka Corporation.

### 5. Mold

As the mold for a shaping purpose, a mold was used that was of a top/bottom separate type with a material of pre-hardened steel NAK80 produced by Daido Steel Co., Ltd. Inside the mold in a closed state, a space (approximately 63 cm³) is formed that is able to shape the separator. Further, the inner bottom parts of the top and the bottom molds each have an uneven surface formed for forming the grooves of the separator.

### 6. Evaluation Methods

### (1) Volume Resistivity

The volume resistivity of the separator was measured by using a device (Loresta-GX T-700) produced by Nittoseiko Analytech Co., Ltd., according to JIS K7194. A volume resistivity value smaller than 2.5 mΩ·cm was evaluated as a pass.

### (2) Bending Test

A bending test for the separators was performed by using a device (Autograph AG-100kNG) produced by Shimadzu Corporation, according to JIS K7171.

### Bending Strength

A bending strength exceeding 40 MPa was evaluated as a pass.

### Bending Strain

A bending strain exceeding 0.7% was evaluated as a pass.

### (3) 23° C. He Gas Permeability Coefficient

The gas permeability coefficient of the separator was measured using He gas based on JIS K7126-1, using a gas permeability measuring device (K-315-N-03) produced by Rika Seiki Kougyou Co., Ltd. A permeability coefficient less than 1.0×10⁻¹⁵ mol·m/m²·sec·Pa was evaluated as a pass.

### 7. Production of Multilayer Separators

### Examples

### (1) Example 1

The following were prepared and mixed and dispersed in water to produce a slurry with a solid content of 1%: 977.8 parts by mass of artificial graphite particles (model number: 1707SJ) and 244.4 parts by mass of artificial graphite particles (model number: AT-No. 5S), 100 parts by mass of PPS powder, and 62.5 parts by mass of para-aramid fiber (Technora T32PNW 3-12) and 4.2 parts by mass of para-aramid fiber (Twaron (registered trademark) D8016). The mixture was input to a strainer comprising an input opening of a 25 cm square, to obtain a wet sheet, which was a sheet formed with residue from the straining. The wet sheet was set on a presser heated to 150° C. and pressured and heated for approximately 20 minutes with surface pressure of 8 MPa. By drying the wet sheet and removing the moisture, a precursor plate having a thickness of 1 mm and an area-based weight of 1100 g/m² was produced in which the artificial graphite particles, the PPS particles, and the aramid fibers were dispersed. One more precursor plate was produced by the same procedure as above, and a total of two precursor plates were prepared. A PPS film having a thickness of 9 μm was placed, as the surface layer film, in the recessed part inside the bottom mold structuring the separate-type mold, and one of the above-mentioned precursor plates was supplied to the top of the film. Next, a PPS film having a thickness of 25 μm was placed thereon as a middle layer film. Next, the other precursor plate was supplied on the PPS film as the middle layer film. Next, a PPS film having a thickness of 9 μm was placed over the precursor plate as the surface layer film. Subsequently, a shaping process was performed by closing together the top mold and the bottom mold structuring the separate-type mold. The shaping process was performed by applying heat until the temperature of the mold reached 340° C. with surface pressure of 4 MPa, then increasing the surface pressure to 90 MPa, and holding the workpiece for one minute. Subsequently, while keeping the pressure the same, the mold was cooled under pressure until the temperature reached 30° C. When the shaping process was finished, the mold was opened to take out the shaped body, and the production of the separator was thus finished. The separator was evaluated by using the above-mentioned evaluation method.

### (2) Example 2

A separator was produced and evaluated under the same conditions as in Example 1, except that a SUS304 film was used as the middle layer film.

### (3) Example 3

A separator was produced and evaluated under the same conditions as in Example 1, except that a graphite film was used as the middle layer film.

### (4) Example 4

A separator was produced and evaluated under the same conditions as in Example 1, except that a PEEK film was used as the middle layer film.

### Comparison Examples

### (1) Comparison Example 1

The ingredients of the precursor plate, the parts by mass of the ingredients, and the producing method were the same as in Example 1, and a precursor plate having a thickness of 2 mm and an area-based weight of 2200 g/m² was produced. The above-mentioned precursor plate was supplied in the inner recessed part of the bottom mold structuring the separate-type mold. Subsequently, a shaping process was performed by closing together the top mold and the bottom mold structuring the separate-type mold. The shaping process was performed by applying heat until the temperature of the mold reached 340° C. with surface pressure of 4 MPa, then increasing the surface pressure to 90 MPa, and holding the workpiece for one minute. Subsequently, while keeping the pressure the same, the mold was cooled under pressure until the temperature reached 30° C. After the shaping process was completed, the mold was opened and the shaped body was taken out, thereby completing the production of a separator having no middle layer film or surface layer film. The separator was evaluated in the same manner as in Example 1.

### (2) Comparison Example 2

A precursor plate similar to Comparative Example 1 was produced. A PPS film having a thickness of 9 μm was placed, as the surface layer film, in the recessed part inside the bottom mold structuring the separate-type mold, and the above-mentioned precursor plates was supplied to the top of the film. Next, a PPS film having a thickness of 9 μm was placed over the precursor plate as the surface layer film. Subsequently, a shaping process was performed by closing together the top mold and the bottom mold structuring the separate-type mold. The shaping process was performed by applying heat until the temperature of the mold reached 340° C. with surface pressure of 4 MPa, then increasing the surface pressure to 90 MPa, and holding the workpiece for one minute. Subsequently, while keeping the pressure the same, the mold was cooled under pressure until the temperature reached 30° C. When the shaping process was finished, the mold was opened to take out the shaped body, and the production of the separator without a middle layer film was thus finished. The separator was evaluated in the same manner as in Example 1.

### 8. Results

Tables 1 presents the producing conditions of Examples and Comparison Examples, together with evaluation results.

TABLE 1

| | | | | | | Comparison | Comparison |
|---|---|---|---|---|---|---|---|
| | | Example 1 | Example 2 | Example 3 | Example 4 | Example 1 | Example 2 |
| Film | Surface layer | PPS | PPS | PPS | PPS | none | PPS |
| | film | | | | | | |
| | Thickness | 9 | 9 | 9 | 9 | 0 | 9 |
| | (μm) | | | | | | |
| | Middle layer | PPS | SUS304 | Graphite | PEEK | none | none |
| | film | | | | | | |
| | Thickness | 25 | 20 | 32 | 6 | 0 | 0 |
| | (μm) | | | | | | |
| Volume resistivity | <2.5 | 2.08 | 2.32 | 1.33 | 2.02 | 1.71 | 1.87 |
| (mΩ · cm) | | | | | | | |
| Bending strength | >40 | 72.6 | 77.2 | 70.0 | 71.1 | 53.4 | 54.8 |
| (MPa) | | | | | | | |
| Bending strain | >0.7 | 1.42 | 1.43 | 1.19 | 1.38 | 1.4 | 1.3 |
| (%) | | | | | | | |
| Gas permeability | <1.0E−15 | 5.99E−17 | 1.60E−16 | 6.02E−17 | 5.59E−17 | 2.29E−12 | 6.13E−15 |
| coefficient | | | | | | | |
| (mol · m/m² · sec · Pa) | | | | | | | |

Regarding Comparative Examples 1 and 2, the volume resistivity, bending strength, and bending strain passed, but the He gas permeability coefficient failed. In contrast, regarding Examples 1 to 4, all the properties were each evaluated as a pass.

### INDUSTRIAL APPLICABILITY

The multilayer separator according to the present invention can be used as a separator between cells in cells, especially storage cells.

1. A multilayer separator comprising:
a plate that contains graphite and resin and comprises a groove serving as a flow path on a surface of the plate; and
at least one internal barrier layer, for a gas barrier, that is inside the plate in a thickness direction and divides the thickness direction into at least two areas.

2. The multilayer separator of claim 1, wherein the internal barrier layer is a film-like layer different from the plate.

3. The multilayer separator of claim 1, wherein the internal barrier layer is a filling layer in which resin or rubber fills spaces between particles or fibers structuring the plate.

4. The multilayer separator of claim 3, wherein the internal barrier layer comprises the filling layer and a film-like layer different from the plate.

5. The multilayer separator of claim 1, further comprising two or more of the internal barrier layers.

6. The multilayer separator of claim 1, wherein the internal barrier layer contains at least one selected from between polyether ether ketone and polyphenylene sulfide.

7. The multilayer separator of claim 1, wherein the internal barrier layer contains at least one selected from between stainless steel and graphite.

8. The multilayer separator of claim 1, further comprising at least one surface barrier layer for a gas barrier on at least one side surface of the plate in the thickness direction.

9. The multilayer separator of claim 8, wherein the surface barrier layer contains at least one selected from between polyether ether ketone and polyphenylene sulfide.

10. The multilayer separator of claim 8, comprising the internal barrier layer and the surface barrier layer,
wherein a thickness of the internal barrier layer is larger than a thickness of the surface barrier layer.

11. The multilayer separator of claim 1, the multilayer separator being a fuel cell separator to be used between cells in a fuel cell.

12. A method for producing the multilayer separator of claim 1, the method comprising:
a first mixture supplying step of supplying a mixture containing graphite and resin into a mold;
a middle layer film arranging step of arranging a middle layer film for forming the internal barrier layer over the mixture in the mold;
a second mixture supplying step of supplying the mixture over the middle layer film; and
a shaping step of forming a shaped body by hardening a layered structure containing at least the mixture, the middle layer film, and the mixture,
wherein the middle layer film arranging step and the second mixture supplying step are each repeated once or more before the shaping step.

13. The method for producing the multilayer separator of claim 12, the multilayer separator comprising the internal barrier layer and at least one surface barrier layer for a gas barrier on at least one side surface of the plate in the thickness direction, the method comprising
a surface layer film arranging step of arranging a surface layer film, for forming the surface barrier layer, in a mold,
wherein the first mixture supplying step, the middle layer film arranging step and the second mixture supplying step are performed after, before, or both before and after the surface layer film arranging step.

14. The method for producing the multilayer separator of claim 12, wherein a pre-shaping step is performed for obtaining the layered structure in a semi-hardened state before the shaping step.

15. The method for producing the multilayer separator of claim 14, wherein the surface layer film arranging step is performed between the pre-shaping step and the shaping step.

16. The method for producing the multilayer separator of claim 12, wherein the multilayer separator is a fuel cell separator to be used between cells in a fuel cell.
